(19) United States
(12) Patent Application Publication
(10) Pub. No.: US 2012/0053973 A1
(43) Pub. Date: Mar. 1, 2012

(54) METHOD OF REPAIRING FINANCIALLY INFEASIBLE GENETIC ALGORITHM CHROMOSOME ENCODING ACTIVITY START TIMES IN SCHEDULING

(75) Inventors: ASHRAF ELAZOUNI, DHAHRAN (SA); MOHAMED ABIDO, DHAHRAN (SA); SHOKRI SELIM, DHAHRAN (SA); ANAS AL-GHAZI, DHAHRAN (SA)

(73) Assignee: KING FAHD UNIVERSITY OF PETROLEUM AND MINERALS, DHAHRAN (SA)

(21) Appl. No.: 12/872,690

(22) Filed: Aug. 31, 2010

(51) Int. Cl. G06Q 10/00; G06Q 40/00; G06N 3/12

(52) U.S. Cl. 705/7.12; 706/13

(57) ABSTRACT

The method of repairing financially infeasible genetic algorithm chromosome encoding activity start times in scheduling problems determines cash availability during a given period, identifies all possible activities' schedules, determines the cash requirements for each schedule, ranks schedules based on the contribution on minimizing the increase in the project duration, schedules all activities of the selected schedule, and determines the impact of the scheduled activities on the project cash flow. Thus, the algorithm introduces effective chromosomes that maximize the utilization of the available funds and minimize project duration.

### BACKGROUND OF THE INVENTION

1. Field of the Invention

The present invention relates to software for designing and managing construction projects, and particularly to a method for repairing financially infeasible chromosomes encoding activity start times in scheduling problems that maximizes the utilization of available funds and minimizes project duration.

2. Description of the Related Art

A genetic algorithm (GA) is a search technique used in computing to find exact or approximate solutions to optimization and search problems. Genetic algorithms are categorized as global search heuristics. Genetic algorithms are a particular class of evolutionary algorithms (EA) that use techniques inspired by evolutionary biology, such as inheritance, mutation, selection, and crossover.

Genetic algorithms are implemented in a computer simulation in which a population of abstract representations (called chromosomes or the genotype of the genome) of candidate solutions (called individuals, creatures, or phenotypes) to an optimization problem evolves toward better solutions. Traditionally, solutions are represented in binary as strings of 0s and 1s, but other encodings are also possible. The evolution usually starts from a population of randomly generated individuals and happens in generations. In each generation, the fitness of every individual in the population is evaluated, multiple individuals are stochastically selected from the current population (based on their fitness), and modified (recombined and possibly randomly mutated) to form a new population. The new population is then used in the next iteration of the algorithm. Commonly, the algorithm terminates when either a maximum number of generations has been produced, or a satisfactory fitness level has been reached for the population. If the algorithm has terminated due to a maximum number of generations, a satisfactory solution may or may not have been reached.

Genetic algorithms find application in bioinformatics, phylogenetics, computational science, engineering, economics, chemistry, manufacturing, mathematics, physics and other fields. A typical genetic algorithm requires a genetic representation of the solution domain and a fitness function to evaluate the solution domain.

A standard representation of the solution is as an array of bits. Arrays of other types and structures can be used in essentially the same way. The main property that makes these genetic representations convenient is that their parts are easily aligned due to their fixed size, which facilitates simple crossover operations. Variable length representations may also be used, but crossover implementation is more complex in this case. Tree-like representations are explored in genetic programming and graph-form representations are explored in evolutionary programming.

In genetic algorithms, crossover is a genetic operator used to vary the programming of a chromosome or chromosomes from one generation to the next. It is analogous to reproduction and biological crossover, upon which genetic algorithms are based. In a “one-point” crossover, a single crossover point on both parents' organism strings is selected. All data beyond that point in either organism string is swapped between the two parent organisms. The resulting organisms are the children.

Two-point crossover calls for two points to be selected on the parent organism strings. Everything between the two points is swapped between the parent organisms, rendering two child organisms. Another crossover variant, the “cut and splice” approach, results in a change in length of the children strings. The reason for this difference is that each parent string has a separate choice of crossover point. In the above schemes, the two parents are combined to produce two new offspring.

In the “uniform crossover” scheme (UX), individual bits in the string are compared between two parents. The bits are swapped with a fixed probability, typically 0.5. In the half uniform crossover scheme (HUX), exactly half of the non-matching bits are swapped. Thus, first, the Hamming distance (i.e., the number of differing bits) is calculated. This number is divided by two. The resulting number is how many of the bits that do not match between the two parents will be swapped.

Depending on how the chromosome represents the solution, a direct swap may not be possible. One such case is when the chromosome is an ordered list, such as an ordered list of the cities to be traveled for the traveling salesman problem. A crossover point is selected on the parents. Since the chromosome is an ordered list, a direct swap would introduce duplicates and remove necessary candidates from the list. Instead, the chromosome up to the crossover point is retained for each parent. The information after the crossover point is ordered as it is ordered in the other parent. For example, if our two parents are ABCDEFGHI and IGAHFDBEC and our crossover point is after the fourth character, then the resulting children would be ABCDIGHFE and IGAHBCDEF.

The “fitness function” is defined over the genetic representation and measures the quality of the represented solution. The fitness function is always problem dependent. For example, in the knapsack problem, one wants to maximize the total value of objects that can be put in a knapsack of some fixed capacity. A representation of a solution might be an array of bits, where each bit represents a different object, and the value of the bit (0 or 1) represents whether or not the object is in the knapsack. Not every such representation is valid, as the size of objects may exceed the capacity of the knapsack. The fitness of the solution is the sum of values of all objects in the knapsack if the representation is valid, or 0 otherwise. In some problems, it is hard or even impossible to define the fitness expression; in these cases, interactive genetic algorithms are used.

Once the genetic representation and the fitness function are defined, GA proceeds to initialize a population of solutions randomly, then improve it through repetitive application of mutation, crossover, inversion and selection operators. Initially, many individual solutions are randomly generated to form an initial population. The population size depends on the nature of the problem, but typically contains several hundreds or thousands of possible solutions. Traditionally, the population is generated randomly, covering the entire range of possible solutions (i.e., the “search space”). Occasionally, the solutions may be “seeded” in areas where optimal solutions are likely to be found.

During each successive generation, a proportion of the existing population is selected to breed a new generation. Individual solutions are selected through a fitness-based process, where fitter solutions (as measured by a fitness function) are typically more likely to be selected. Certain selection methods rate the fitness of each solution and preferentially select the best solutions. Other methods rate only a random sample of the population, as this process may be very time-consuming.

Most functions are stochastic and designed so that a small proportion of less fit solutions are selected. This helps keep the diversity of the population large, preventing premature convergence on poor solutions. Popular and well-studied selection methods include roulette wheel selection and tournament selection.

The next step is to generate a second generation population of solutions from those selected through genetic operators: crossover (also called recombination), and/or mutation. For each new solution to be produced, a pair of “parent” solutions is selected for breeding from the pool selected previously. By producing a “child” solution using the above methods of crossover and mutation, a new solution is created which typically shares many of the characteristics of its “parents”. New parents are selected for each child, and the process continues until a new population of solutions of appropriate size is generated. Although reproduction methods that are based on the use of two parents are more “biology inspired”, recent research suggests more than two “parents” are better to be used to reproduce a good quality chromosome.

These processes ultimately result in the next generation population of chromosomes that is different from the initial generation. Generally, the average fitness will have increased by this procedure for the population, since only the best organisms from the first generation are selected for breeding, along with a small proportion of less fit solutions, for the reasons noted above.

This generational process is repeated until a termination condition has been reached. Common terminating conditions include: a solution is found that satisfies minimum criteria; a fixed number of generations are reached; an allocated budget (computation time/money) is reached; the highest ranking solution's fitness is reaching or has reached a plateau such that successive iterations no longer produce better results; manual inspection or combinations of the above.

The process generally follows the steps of: Choose the initial population of individuals; evaluate the fitness of each individual in that population; repeat on this generation until termination; select the best-fit individuals for reproduction; breed new individuals through crossover and mutation operations to give birth to offspring; evaluate the individual fitness of new individuals; and replace least-fit population with new individuals.

In genetic algorithms, mutation is a genetic operator used to maintain genetic diversity from one generation of a population of chromosomes to the next. It is analogous to biological mutation. An example of a mutation operator is a probability that an arbitrary bit in a genetic sequence will be changed from its original state. A common method of implementing the mutation operator involves generating a random variable for each bit in a sequence. This random variable tells whether or not a particular bit will be modified.

The purpose of mutation in GAs is to allow the algorithm to avoid local minima by preventing the population of chromosomes from becoming too similar to each other, thus slowing or even stopping evolution. This reasoning also explains the fact that most GA systems avoid only taking the fittest of the population in generating the next, but rather a random (or semi-random) selection with a weighting toward those that are fitter.

As noted above, in GAs, potential solutions to a problem are represented as a population of chromosomes. Each chromosome in turn is composed of a string of values each is being referred to as a gene. The chromosomes evolve through successive generations. In order to exploit and explore potential solutions, offspring chromosomes are created by merging two parent chromosomes using a crossover operator or modifying an existing chromosome using a mutation operator. There are many methods of crossover and mutation operators.

The method of gene coding in a chromosome hinges upon the particular problem at hand. The typical time/cost trade-off problem can be formulated as a numerical optimization problem in the GAs. In this particular problem, the values of the genes in a chromosome represent possible durations of the project activities. The one-cut-point crossover and uniform mutation operators can be used efficiently for the time/cost trade-off problems. Resource allocation problems represent a typical ordering problem, as the main concern is to determine the activities' priority to fulfill the constrained resources. Accordingly, the genes represent activities' identifications and a chromosome represents a possible order of activities. A chromosome structure can be such that an activity in a higher order, from left to right, has a higher priority of getting resources than the previous activities. However, there is a possibility that character duplication and/or omission occurs after implementing the crossover and mutation operators.

Likewise, the unlimited resource leveling problem can be translated into a normal numerical optimization problem using GA techniques. Resource leveling problems represent a typical scheduling problem with the objective of minimizing the fluctuation in resource usage. The genes represent activities' start times and a chromosome represents a possible project schedule. In contrast with ordering problems, scheduling problems features specific precedence relationships among genes. Accordingly, the implementation of the one-cut-point crossover and uniform mutation operators for the leveling problem may cause violation of the precedence relationships of the offspring chromosomes. This problem entails checking the output chromosomes of the crossover and mutation operators and repairing of the infeasible chromosomes. This check/repair process causes considerable computational inefficiency to the GA technique.

It would be desirable to generate and employ precedence-preserving crossover and mutation operators for chromosomes encoding activities' start times to avoid the inefficiency caused by the basic GAs technique, through detecting and repairing the infeasible chromosomes each time these operators are performed.

A crucial challenge for construction contractors to run a sustained business is the ability to timely procure adequate money to execute construction operations. Besides owners' payments, contractors often procure an additional component of funding from external sources, including bank credit lines to supplement owners' payments. Given the facts that the owners actually pay after the accomplishment of the work, while retaining some amount of money, and the cash that contractors are allowed to withdraw from credit-line accounts is limited in amount, contractors often operate under cash-constrained conditions. Accordingly, the premise that the best proactive operating strategy contractors can follow for effective financial planning is to schedule the construction activities based on the cash availability is strongly advocated.

Typically, an additional cost component for financing is associated with cash procurement through the banks' credit lines. Contractors normally deposit owners' progress payments into the credit-line accounts to continually reduce the outstanding debit and, consequently, the financing costs. Contractors charge the expenses caused by labor, equipment, materials, subcontractors, and other indirect costs (Er) against, and deposit progress payments (Pₜ) into the credit-line accounts. It can be reasonably assumed in practice that these transactions occur as of the cut-off times between periods.

Accordingly, the values of the outstanding debt F as of the cut-off times are determined. The financing costs Îₜ as of the cut-off times are determined by applying the prescribed interest rate to the outstanding debt. The summations of the values of the outstanding debt and the accumulated financing costs constitute the negative cumulative balance \hat{F}ₜ. The cumulative net balance values \hat{N}ₜ constitute the negative cumulative balances after depositing the progress payments. The cumulative net balance of all Eₜ, Pₜ, and Îₜ transactions constitutes the profit G as of the end of the project.

Another concern of financing, though more important than the incorporation of financing costs, constitutes the credit-limit constraints imposed on the credit lines. The credit limit specifies the maximum value the negative cumulative balance is allowed to reach as of any cut-off time. Thus, finance-based scheduling incorporates financing costs into the project total cost as well as schedules activities' such that the contractor's negative cumulative balance as of any cut-off time never top the specified credit limit. The optimization techniques employed to devise finance-based schedules normally fulfill these two goals with the objective of maximizing the profit at the end of the project. This objective is directly conducive to the minimization of the indirect costs through minimizing the project duration, and the financing costs. In order to achieve this objective, a search technique based on artificial intelligence (i.e., the GAs technique) is used.

Implementing the GA technique in the problem of finance-based scheduling involves the steps of: devising a schedule extension scheme; setting chromosome structure; defining the chromosome evaluation criterion; generating an initial population of chromosomes; employing an offspring generation crossover and mutation operators; and coding the procedure in a computer program.

The project cash-flow diagram in FIG. 4 illustrates the activities' cash outflow during a typical period t, where the taxes and the overheads are represented by Eₜ, and the corresponding activities' cash inflow is received at the end of the same period t (represented by Pₜ).

The net cumulative balance as of the end of the previous period t after receiving a cash inflow Pₜ is represented as Nₜ, where

Nₜ=Fₜ+Pₜ; (1)

and

F=Nₜ₋₁+Eₜ. (2)

Accordingly, the total financing costs as of the end of period t (represented as Iₜ) is given by:

$${I}_{t} = {rN}_{t - 1} + r \frac{{E}_{t}}{2} . \qquad ( 3 )$$

In equation (3), the first component of Iₜ represents the financing cost for period t on the net cumulative balance Nₜ₋₁. The second component approximates the financing cost on Eₜ for period t. The financing rate per period is represented as r.

If the payment of the financing cost is deferred, the periodical Iₜ should be compounded at a financing rate r, and the cumulative balance as of the end of period t, including accumulated financing costs, (represented as Fₜ) is given by:

\hat{F}ₜ=Fₜ+Îₜ (4)

where the second term, Îₜ, represents the accumulated financing costs as of the end of period t:

$${\hat{I}}_{t} = {\sum }_{l = 1}^{t} {{I}_{l} ( 1 + r )}^{t - l} . \qquad ( 5 )$$

Similar to equation (4), the net cumulative balance, including accumulated financing costs as of the end of period t, is represented as \hat{N}ₜ:

\hat{N}ₜ=Nₜ+Îₜ. (6)

For period t−1, FIG. 4 shows the cumulative balance as of the end of this period, including accumulated financing costs \hat{F}ₜ₋₁ and the net cumulative balance \hat{N}ₜ₋₁. Additionally, FIG. 4 shows the same parameters as of the end of period t.

In GA-based scheduling problems, the chromosome structure features a string of genes with the number of genes being the same as the number of activities in the critical path method (CPM) network. The gene values correspond to the start times assigned to the activities. A schedule and its equivalent chromosome become financially feasible when the values of the negative cumulative balance value at any period t, including the accumulated financing costs \hat{F}ₜ never top the value of a specified limit W, which represents the constrained fund. These constraints can be formulated as:

|\hat{F}ₜ|≦|W| (7)

where t=1, 2, 3, . . . , L.

Thus, a method of repairing financially infeasible genetic algorithm chromosome encoding activity start times in scheduling problems solving the aforementioned problems is desired.

### SUMMARY OF THE INVENTION

Conventional genetic algorithm operators are incapable of preserving financial feasibility in scheduling problems. The method of repairing financially infeasible genetic algorithm chromosome encoding activity start times in scheduling problems determines cash availability during a given period, identifies all possible activities' schedules, determines the cash requirements for each schedule, ranks schedules based on the contribution on minimizing the increase in the project duration, schedules all activities of the selected schedule, and determines the impact of the scheduled activities on the project cash flow.

Thus, the method introduces effective chromosomes that maximize the utilization of the available fund and minimize the project duration. The method includes the steps of: (a) establishing a database stored in computer readable memory; (b) defining a set of variables E(t), P(t) and Uₜ respectively representing a set of activities' cash outflow over a period of time t, a cash inflow for the set of activities at the end of the period of time t, and a total of cash outflow during the period of time t; (c) setting t=0; (d) establishing an initial value of the set of activities' cash outflow E(0) and an initial value of the cash inflow for the set of activities P(0) at time t=0 and storing E(0) and P(0) in the database; (e) iteratively advancing the time period t so that t=t+1; (f) establishing the total of cash outflow Uₜ for the period of time t and storing Uₜ in the database; (g) determining cash outflows associated with a set of unscheduled activities during the period of time t, Rₜ, and storing Rₜ in the database; (h) identifying all possible schedules of eligible activities based on a set of activities already scheduled prior to the period of time t and storing the set of possible schedules in the database; (i) for each identified schedule in the set of possible schedules, calculating a sum of the cash outflow and financing costs associated therewith; (j) for each identified schedule in the set of possible schedules, determining a time to finish a project associated therewith; (k) for each identified schedule in the set of possible schedules, calculating Uₜ₊₁ and Rₜ₊₁ and storing the calculated Uₜ₊₁ and Rₜ₊₁ in the database; (l) determining the most optimal schedule in the set of possible schedules, wherein the most optimal schedule includes the least delay in time to finish the project associated therewith from the set of possible schedules, has a sum of cash outflow, tax value and financing costs associated therewith less than Rₜ, and the sum is the closest to Rₜ from the set of possible schedules, and Rₜ₊₁ is positive; (m) storing the most optimal schedule in the database; (n) scheduling the activities of the most optimal schedule; (o) determining E(t) and P(t) for cash flow over the period of time t; and (p) if all activities have not been scheduled, then returning to step (e).

These and other features of the present invention will become readily apparent upon further review of the following specification.

### BRIEF DESCRIPTION OF THE DRAWINGS

FIGS. 1A and 1B are a flowchart illustrating method steps of a method of repairing financially infeasible genetic algorithm chromosome encoding activity start times in scheduling problems according to the present invention.

FIGS. 2A and 2B are a table showing cash flow parameters throughout a twelve-week duration for a chromosome representing $50,000 in an example of the method of repairing financially infeasible genetic algorithm chromosome encoding activity start times in scheduling problems according to the present invention.

FIGS. 3A and 3B are a table showing possible schedules of a first project during the fourth week a constrained fund of $53,000 for the example of FIGS. 2A and 2B.

FIG. 4 is a graph illustrating a cash flow profile for a typical project.

FIG. 5 is diagrammatically illustrates a critical path method network for an exemplary twelve-activity project utilizing the method of repairing financially infeasible genetic algorithm chromosome encoding activity start times in scheduling problems according to the present invention.

FIG. 6 diagrammatically illustrates setup of a pair of twelve-activity projects.

FIG. 7 diagrammatically illustrates chromosome encoding of activity early start times in the method of repairing financially infeasible genetic algorithm chromosome encoding activity start times in scheduling problems according to the present invention.

FIG. 8 diagrammatically illustrates an exemplary chromosome under a constrained fund of $53,000.

FIG. 9 diagrammatically illustrates an exemplary chromosome under a constrained fund of $50,000.

FIG. 10 diagrammatically illustrates an exemplary chromosome under a constrained fund of $47,000.

FIG. 11 diagrammatically illustrates an exemplary scheduling of activities during the fourth week at a constrained fund of $53,000 utilizing the method of repairing financially infeasible genetic algorithm chromosome encoding activity start times in scheduling problems according to the present invention.

FIG. 12 is a diagrammatic overview of a system for implementing the method of repairing financially infeasible genetic algorithm chromosome encoding activity start times in scheduling problems according to the present invention.

Similar reference characters denote corresponding features consistently throughout the attached drawings.

### DETAILED DESCRIPTION OF THE PREFERRED EMBODIMENTS

The method of repairing financially infeasible genetic algorithm chromosome encoding activity start times in scheduling problems determines cash availability during a given period, identifies all possible activities' schedules, determines the cash requirements for each schedule, ranks schedules based on the contribution on minimizing the increase in the project duration, schedules all activities of the selected schedule, and determines the impact of the scheduled activities on the project cash flow. Thus, the method introduces effective chromosomes that maximize the utilization of the available funds and minimize the project duration.

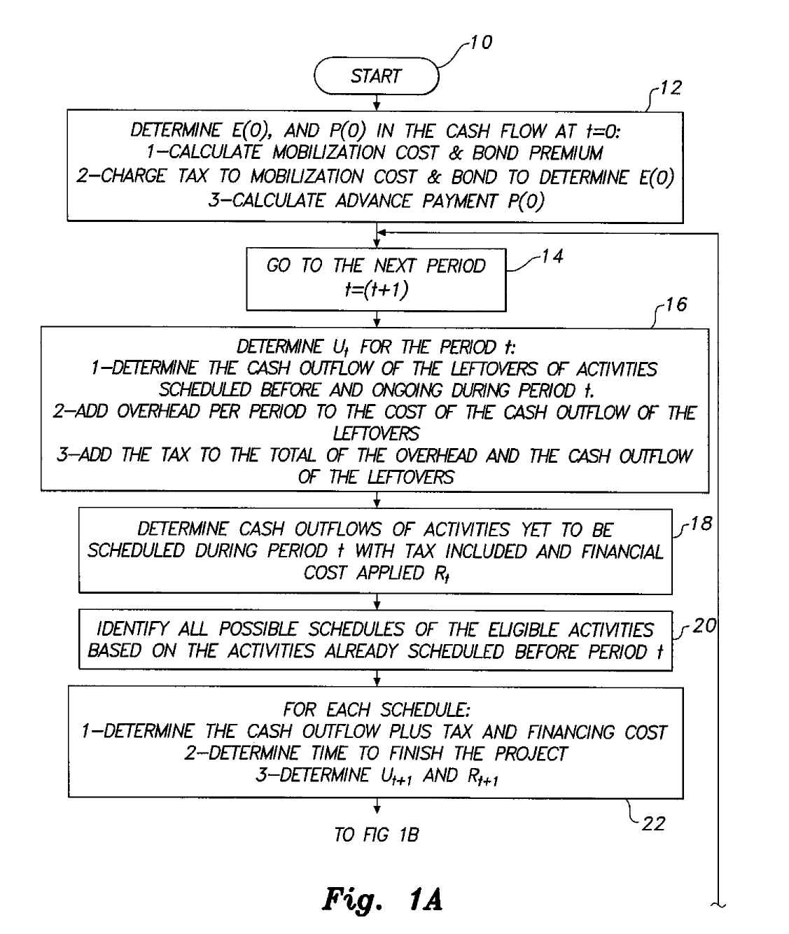

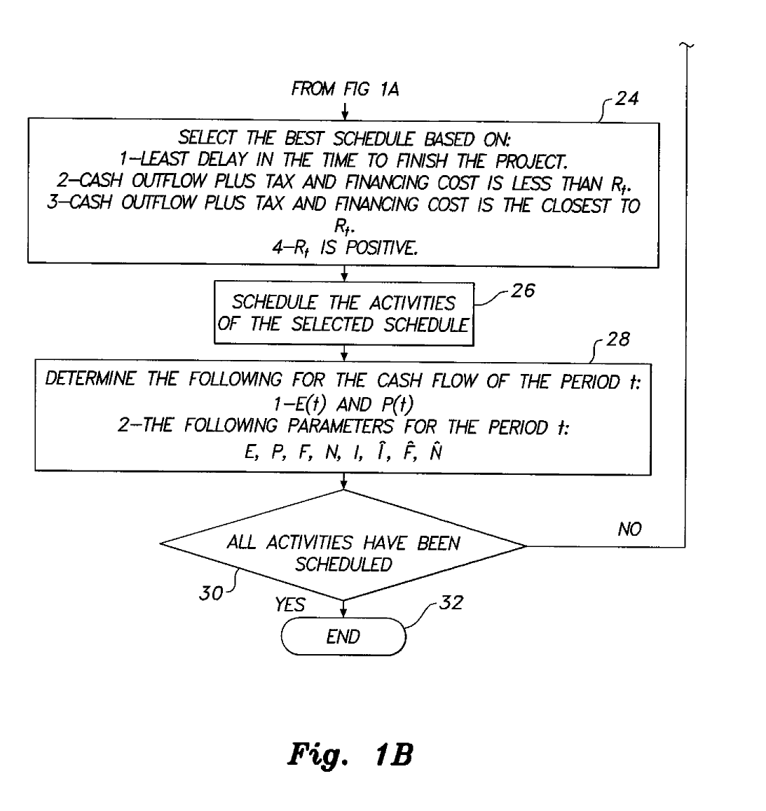

As illustrated in FIGS. 1A and 1B, the method begins at step 10 and includes the following further steps: (a) establishing a database stored in computer readable memory; defining a set of variables E(t), P(t) and Uₜ respectively representing a set of activities' cash outflow over a period of time t, a cash inflow for the set of activities at the end of the period of time t, and a total of cash outflow during the period of time t; (c) setting t=0; (d) establishing an initial value of the set of activities' cash outflow E(0) and an initial value of the cash inflow for the set of activities P(0) at time t=0 and storing E(0) and P(0) in the database (step 12); (e) iteratively advancing the time period t so that t=t+1 (step 14); (f) establishing the total of cash outflow Uₜ for the period of time t and storing Uₜ in the database (step 16); (g) determining cash outflows associated with a set of unscheduled activities during the period of time t, Rₜ, and storing Rₜ in the database (step 18); (h) identifying all possible schedules of eligible activities based on a set of activities already scheduled prior to the period of time t and storing the set of possible schedules in the database (step 20); (i) for each identified schedule in the set of possible schedules, calculating a sum of the cash outflow and financing costs associated therewith; (j) for each identified schedule in the set of possible schedules, determining a time to finish a project associated therewith; (k) for each identified schedule in the set of possible schedules, calculating Uₜ₊₁ and Rₜ₊₁ and storing the calculated Uₜ₊₁ and Rₜ₊₁ in the database (step 22); (l) determining the most optimal schedule in the set of possible schedules, wherein the most optimal schedule includes the least delay in time to finish the project associated therewith from the set of possible schedules, has a sum of cash outflow, tax value and financing costs associated therewith less than Rₜ, and the sum is the closest to R, from the set of possible schedules, and Rₜ₊₁ is positive (step 24); (m) storing the most optimal schedule in the database; (n) scheduling the activities of the most optimal schedule (step 26); (o) determining E(t) and P(t) for cash flow over the period of time t (step 28); and (p) if all activities have not been scheduled, then returning to step (e) (step 30), and if all activities have been scheduled, then the process ends at step 32.

Preferably, the step of establishing an initial value of the set of activities' cash outflow E(0) and an initial value of the cash inflow for the set of activities P(0) at time t=0 (step d) is performed by the following additional steps: (q) establishing a set of mobilization costs and bond premiums associated with the set of activities; (r) calculating a tax value associated with the set of mobilization costs and bond premiums from a tax rate and setting E(0) equal to the tax value; and (s) establishing an advance payment total for the set of activities and setting P(0) equal to the advance payment total.

The step of establishing the total of cash outflow Uₜ for the period of time t (step f) is preferably performed by the following subsequent steps: (t) determining cash outflow of a set of leftovers of activities scheduled prior to and ongoing through the period of time t; (u) adding an overhead per time period to the cash outflow of the set of leftovers; and (v) calculating a leftover tax value and adding the leftover tax value to the sum of the overhead per time period and the cash outflow of the set of leftovers to establish the cash outflow Uₜ for the period t.

In step (g), the cash outflows associated with a set of unscheduled activities during the period of time t, Rₜ are determined with included tax and financing costs, and Rₜ is calculated as

$${R}_{t} = W - {\hat{N}}_{t - 1} - {N}_{t - 1} ( r ) - {\hat{I}}_{t - 1} ( r ) - {U}_{t} ( 1 + \frac{r}{2} ) ,$$

where W is a user-specified limit representing a constrained fund, \hat{N}ₜ represents a net cumulative balance including accumulated financing costs at the end of the period of time t and \hat{N}ₜ₋₁ represents the net cumulative balance including accumulated financing costs at the end of the previous period of time t−1, r represents a financing rate per period of time, Iₜ represents accumulated financing costs at the end of the period of time t, and Îₜ₋₁ represents the accumulated financing costs at the end of the previous period of time t−1.

The maximum amount of cash available to schedule activities at any period t can be determined when the inequality of equation (7) above becomes equation (8):

\hat{F}ₜ=W. (8)

We also have the following conditions:

W=Fₜ+Îₜ (9)

W=(Nₜ₋₁+Eₜ)+Îₜ. (10)

Uₜ is the total of the cash outflow during period t of the leftovers of the activities scheduled prior to period t plus the overhead costs for period t and the tax applied to the total. Vₜ represents the maximum amount of cash outflows of activities yet to be scheduled during period t with tax applied. Thus, the summation of Uₜ and Vₜ is equal to Eₜ:

Eₜ=Uₜ+Vₜ. (11)

The accumulated financing costs Îₜ as of the end of the period t are equal to the accumulated financing costs Îₜ₋₁ at the end of the previous period t−1, compounded for one period plus the financing cost Iₜ for period t. Thus, equation (10) can be rewritten as:

W=(Nₜ₋₁+Uₜ+Vₜ)+(Îₜ₋₁(1+r)+Iₜ. (12)

Substitution of Iₜ (as in equation (3)) yields:

W=(Nₜ₋₁+Uₜ+Vₜ)+Îₜ₋₁+Îₜ₋₁(r)+Nₜ₋₁(r)+(Uₜ+Vₜ)(r/2) (13)

W=Nₜ₋₁+Nₜ₋₁(r)+Îₜ₋₁+Îₜ₋₁(r)+Uₜ(1+r/2)+Vₜ(1+r/2) (14)

Vₜ(1+r/2)=W−Nₜ₋₁−Nₜ₋₁(r)−Îₜ₋₁−Îₜ₋₁(r)−Uₜ(1+r/2) (15)

Vₜ(1+r/2)=W−(Nₜ₋₁+Îₜ₋₁)−Nₜ₋₁(r)−Îₜ₋₁(r)−Uₜ(1+r/2). (16)

If Rₜ is the Vₜ with the financing cost rate applied for one period t, then:

Rₜ=W−\hat{N}ₜ₋₁−Nₜ₋₁(r)−Îₜ₋₁(r)−Uₜ(1+r/2). (17)

Equation (17) indicates that the maximum amounts of cash outflows of activities yet to be scheduled during time period t, with tax included and financing costs applied, should not top the values of Rₜ so that the values of the negative cumulative balance never top the constrained fund of W.

The accumulated financing costs at the end of the period of time t, Îₜ, is calculated as

$${\hat{I}}_{t} = {\sum }_{l = 1}^{t} {{I}_{l} ( 1 + r )}^{t - l} ,$$

where l is an integer and Iₗ represents total financing costs at the end of time t=1.

Step (o) further includes determining Fₜ, Nₜ, Îₜ, \hat{F}ₜ, and \hat{N}ₜ for the period of time t, where Fₜ represents outstanding debt at the end of period of time t, Nₜ represents net cumulative balance at the end of period of time t, and \hat{F}ₜ represents cumulative balance at the end of the period of time t, including accumulated financing costs, and returning to step (e) if all activities have not been scheduled.

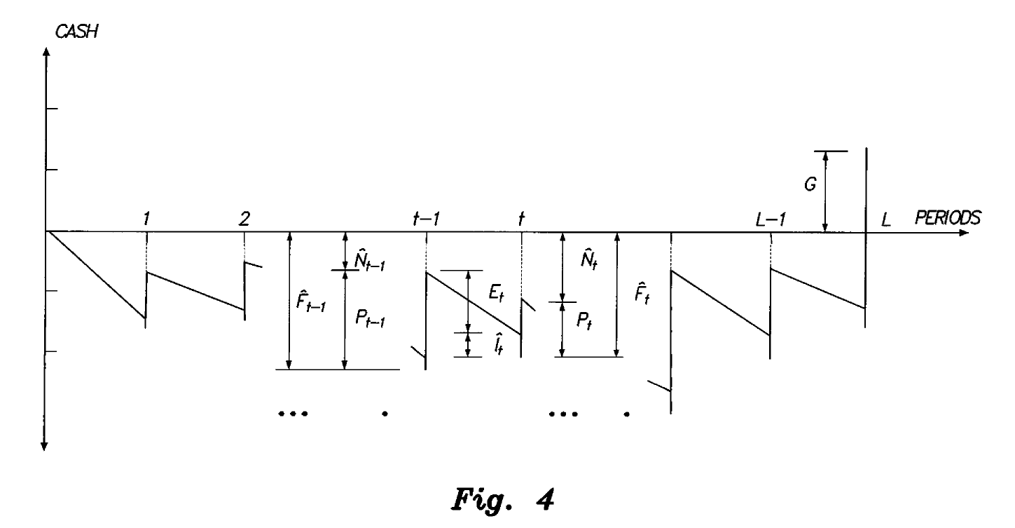

With regard to step (h) and the identification of possible activities' schedules, generally, the cash flow of the project changes at discrete points in time when the cash inflows are received. As shown in FIG. 4, these discrete points in time determine the cash inflow periods of project cash flow. Thus, it is necessary to follow the same cash inflow periods for the purposes of cash outflow calculations, in particular, and for the cash flow analysis in general. This suggests that sets of eligible activities should be considered for possible scheduling during the cash inflow periods for which cash inflows take place at their starts.

The initial schedule of a set of activities during a certain period can be identified by considering all activities eligible to start at the earliest times upon the completion of the respective preceding activities. Additional schedules emerge when a certain activity crosses the border of its current period by at least one day. These activities' crossings change the cash outflow during the current period and, consequently, increase the possibility to meet the constrained fund. The total number of schedules can be determined by enumerating all possible activities' crossings. For all of the determined schedules, the start times of the activities are input into the critical path method network up to the current period and the network calculations are completed to determine the impact of each schedule on the project duration.

As noted above, implementing a GA technique in the problem of finance-based scheduling involves the steps of: devising a schedule extension scheme; setting chromosome structure; defining the chromosome evaluation criterion; generating an initial population of chromosomes; employing an offspring generation crossover and mutation operators; and coding the procedure in a computer program. In the present method, the chromosome is represented by the schedule and step (l) involves the determination of the most fit chromosome; i.e., the most optimal scheduling solution.

With regard to the selection of the most optimal schedule in step l), the method works on a periodic basis to schedule activities fulfilling the constrained fund, and constructs the cash flow as the scheduling process proceeds. Additionally, the method achieves the maximum utilization of the fund available during a certain period. At the beginning of the project, as shown in FIG. 1A, the cash outflow encompasses the mobilization costs and bond premium, and the cash inflow constitutes the advance payment (step 12). For any subsequent period t, Uₜ and Rₜ are determined as described above.

The possible schedules of activities during the period t are identified along with the activities' cash outflows plus tax, along with financing costs, the time to finish the project, and the values of Uₜ₊₁ and Rₜ₊₁. The most optimal schedule is selected, with the most optimal being the schedule which exhibits the minimum delay in the project completion, where the summation of the cash outflow plus tax and financing costs is less than Rₜ, where the summation is the closest to Rₜ, and the value of Rₜ₊₁ is positive to ensure that cash will be available to implement the leftovers of this schedule during the subsequent period t+1. Finally, the cash inflow and outflow are determined for period t, and consequently the other financial parameters of the cash flow.

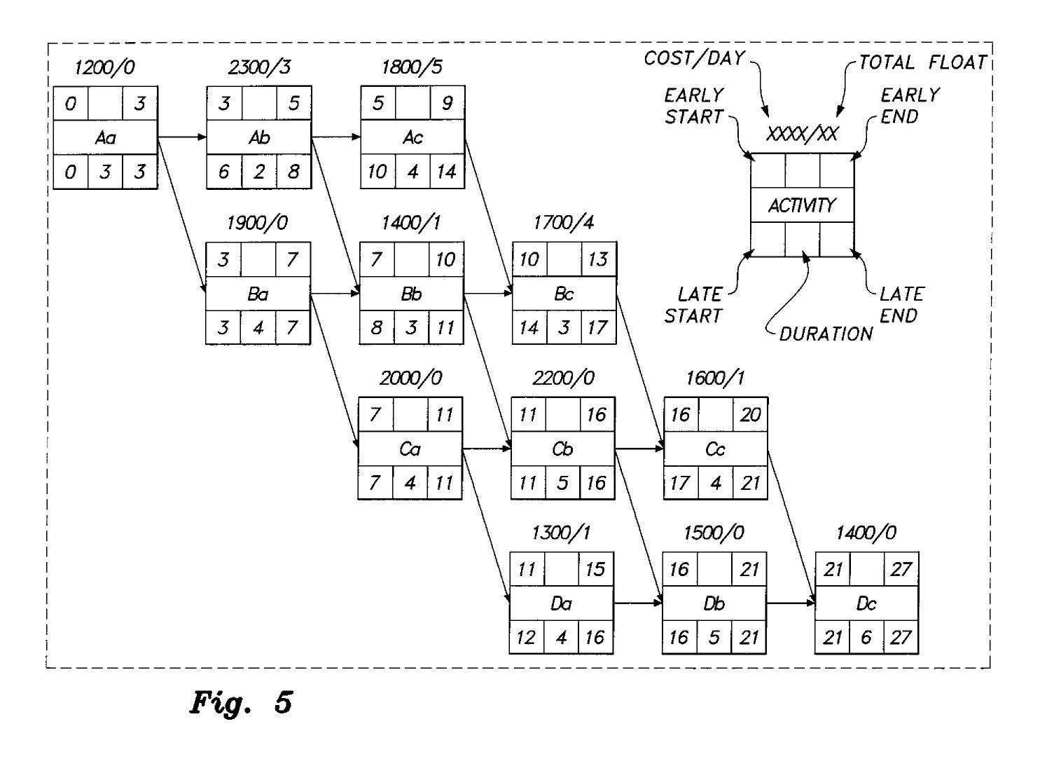

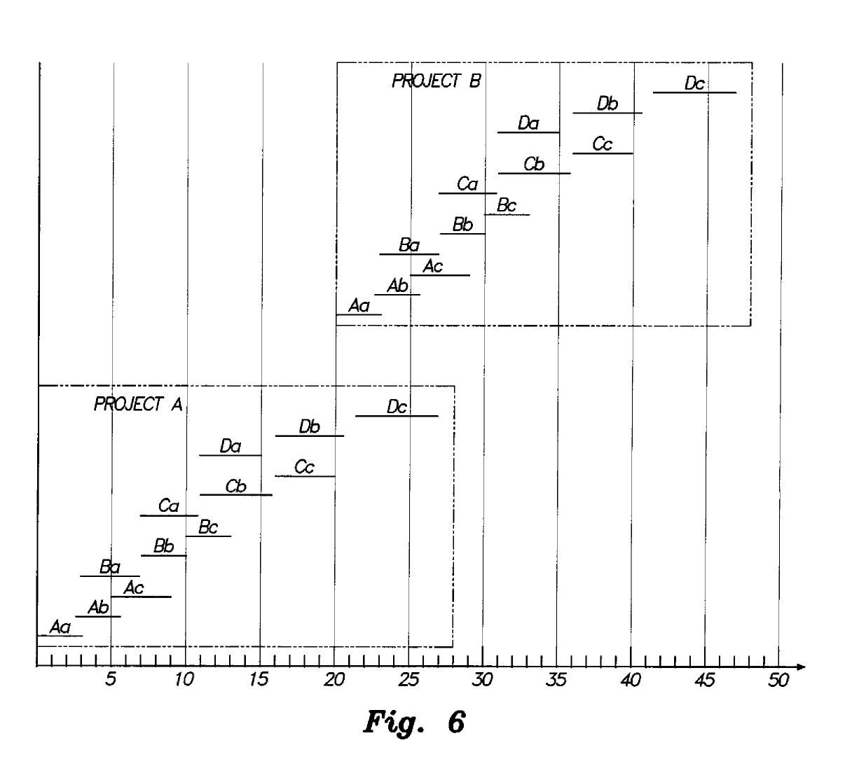

In a first example, the method is demonstrated using two concurrent projects, A and B, of a 12-activity critical path method (CPM) network, as illustrated diagrammatically in FIG. 5. More than one project is considered because financial planning is typically achieved at the company level considering all ongoing projects. As shown in FIG. 6, the two 12-activity projects are set up so that the start of project B lags four weeks beyond the start of project A. The duration of each project spans over 27 working days (i.e., six weeks), and the duration of the two projects together spans over 47 days (i.e., ten weeks).

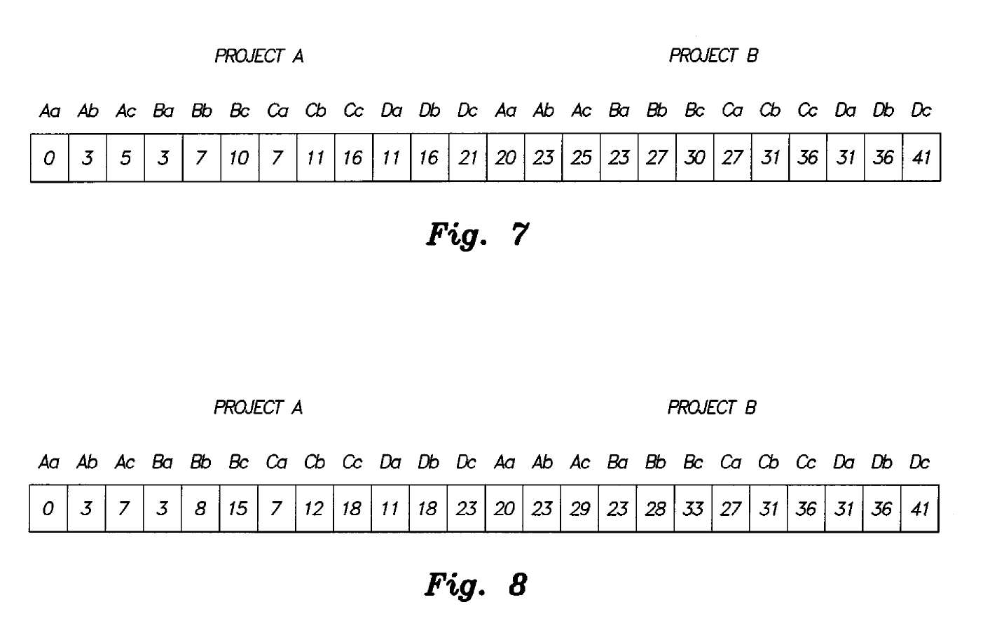

The chromosome of the early-start schedule of the two projects is shown in FIG. 7. The financial data and the contractual terms of the two projects are presented in Table 1 below:

TABLE 1
Financial data and contractual terms of projects A and B

| Category | Item | Project A | Project B |
|---|---|---|---|
| Interest | Interest rate per week | 0.3 | 0.3 |
| rate | | | |
| Financial | Original duration (days) | 27 | 27 |
| data | Original duration (Weeks) | 6 | 6 |
| | Overheads per week | 3500 | 2500 |
| | Mobilization costs | 20000 | 15000 |
| | Tax percentage | 2 | 2 |
| | Markup percentage | 20 | 20 |
| | Bond premium | 2200 | 1300 |
| Contract | Advance payment percentage of | 6 | 4 |
| terms | bid price | | |
| | Weeks to retrieve advance | 6 | 6 |
| | payment | | |
| | Retained percentage of pay | 5 | 7 |
| | requests | | |
| | Lag to pay retained money after | 0 | 0 |
| | last payment (Weeks) | | |
| | Weeks to submit pay requests | 1 | 1 |
| | regularly | | |
| | Lag to pay payment requests | 1 | 1 |
| | (weeks) | | |

Table 2 below shows, for project A, the activities' cash outflow daily rates with the overheads, mobilization costs, tax, markup, and bonds prorated to determine the activities' prices (cash inflows) on a daily basis. Accordingly, the financial parameters of the cash flow model are calculated:

TABLE 2
Rates of cash outflows and inflows of the activities of Project A

| | Duration | Cost per | Total | Total | Price per |
|---|---|---|---|---|---|
| Activity | in days | day | cost | Price | day |
| Aa | 3 | 1200 | 3600 | 6799.6 | 2266.5 |
| Ab | 2 | 2300 | 4600 | 8688.3 | 4344.2 |
| Ac | 4 | 1800 | 7200 | 13599.2 | 3399.8 |
| Ba | 4 | 1900 | 7600 | 14354.7 | 3588.7 |
| Bb | 3 | 1400 | 4200 | 7932.8 | 2644.3 |
| Bc | 3 | 1700 | 5100 | 9632.7 | 3210.9 |
| Ca | 4 | 2000 | 8000 | 15110.2 | 3777.5 |
| Cb | 5 | 2200 | 11000 | 20776.5 | 4155.3 |
| Cc | 4 | 1600 | 6400 | 12088.1 | 3022.0 |
| Da | 4 | 1300 | 5200 | 9821.6 | 2455.4 |
| Db | 5 | 1500 | 7500 | 14165.8 | 2833.2 |
| Dc | 6 | 1400 | 8400 | 15865.7 | 2644.3 |

It should be noted that the prices in Table 2 do not include the financing cost. Total cash outflow is 78,800; overheads are 21,000; mobilization costs are 20,000; the total of cash outflow, overheads and mobilization is 119,800; taxes are 2,396; the total of taxes, cash outflow, overheads and mobilization is 122,196; markup is 24,439; the total of markup, taxes, cash outflow, overheads and mobilization is 146,635; the bond premium is 2,200; the total bid price is 148,835; and the factor to determine price based on cash outflow is (148835.2=78800)=1.888772.

The values of the accumulated negative balance of the two projects, based on calculating Eₜ and Pₜ collectively and proceeding with the calculation of the other financial parameters, associated with the early-start schedule are presented in the first column in Table 3 with a maximum value of $60,120.60:

TABLE 3
Accumulated negative balance values of the two 12-activity
projects of the early start schedule and under three constraint funds

| | Initial | | | |
|---|---|---|---|---|
| Weeks | Schedule | $53,000 | $50,000 | $47,000 |
| 0 | −22664.6 | −22664.6 | −22664.6 | −22664.6 |
| 1 | −29609.4 | −29609.4 | −29609.4 | −29609.4 |
| 2 | −54930.0 | −51661.1 | −49822.3 | −46144.8 |
| 3 | −60120.6* | −52653.7 | −49992.2* | −45486.4 |
| 4 | −53393.6 | −52787.0 | −49679.5 | −46940.1* |
| 5 | −42713.0 | −52956.6* | −48112.8 | −42514.6 |
| 6 | −48704.0 | −52912.5 | −49425.5 | −46062.2 |
| 7 | −43470.6 | −46782.6 | −49658.0 | −46774.9 |
| 8 | −17213.4 | −28055.3 | −49442.4 | −46924.7 |
| 9 | 5582.2 | 2833.9 | −20011.3 | −37403.9 |
| 10 | 22448.1 | 22397.6 | 505.4 | −40609.2 |
| 11 | 32817.2 | 32766.6 | 17687.9 | −12582.7 |
| 12 | — | — | 27897.9 | 6822.0 |
| 13 | — | — | — | 20784.8 |

*Maximum cumulative negative balance.

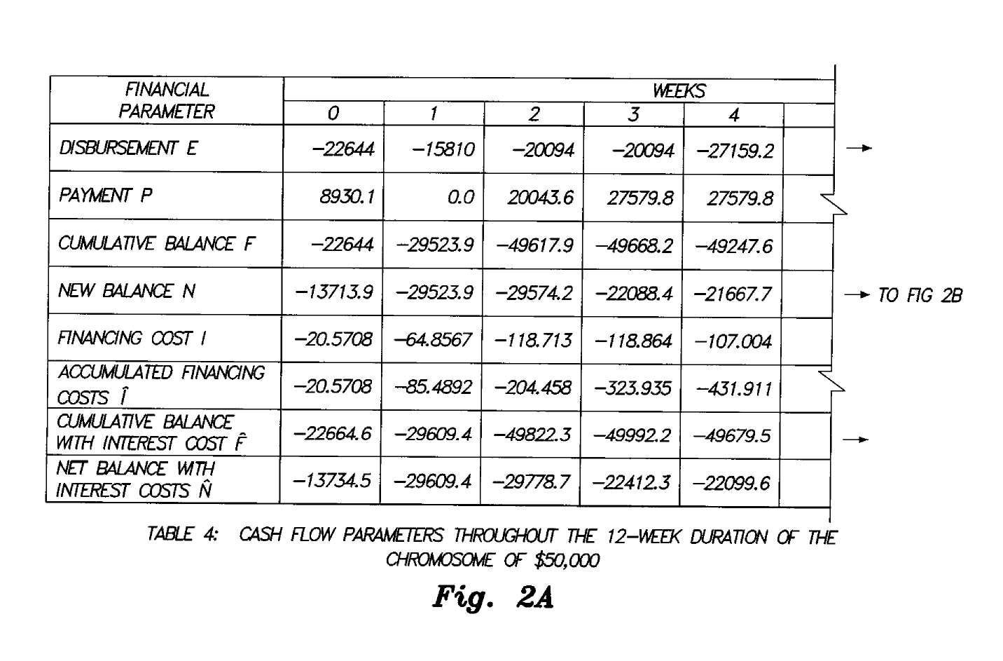

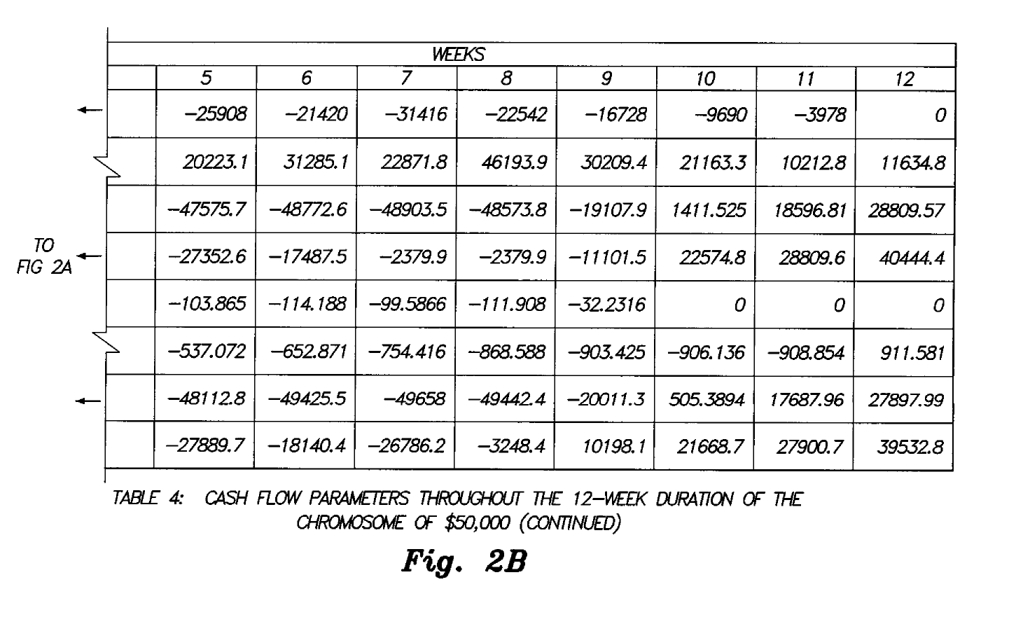

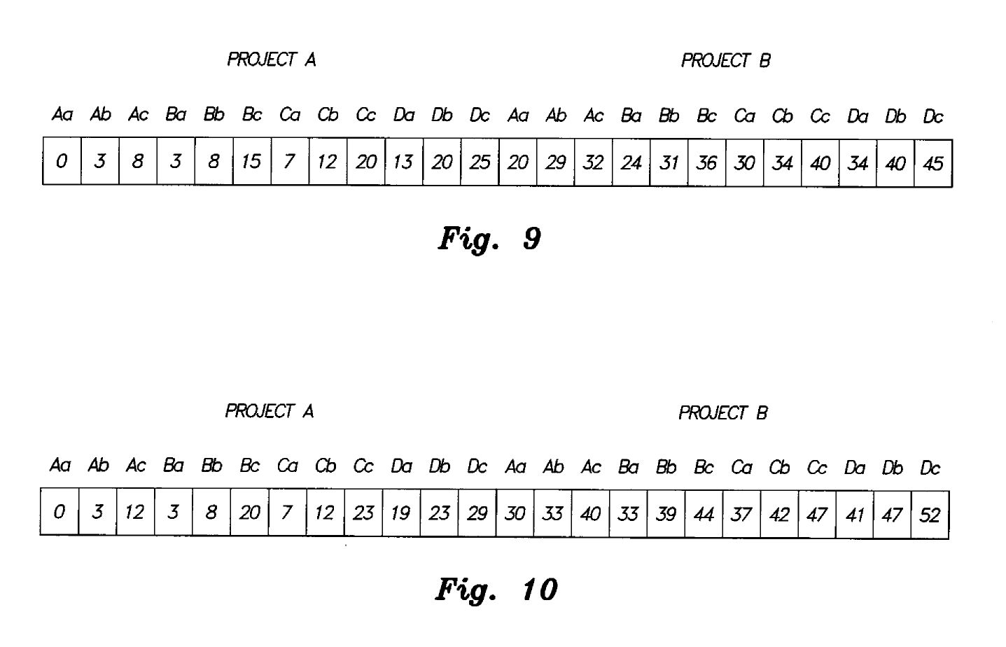

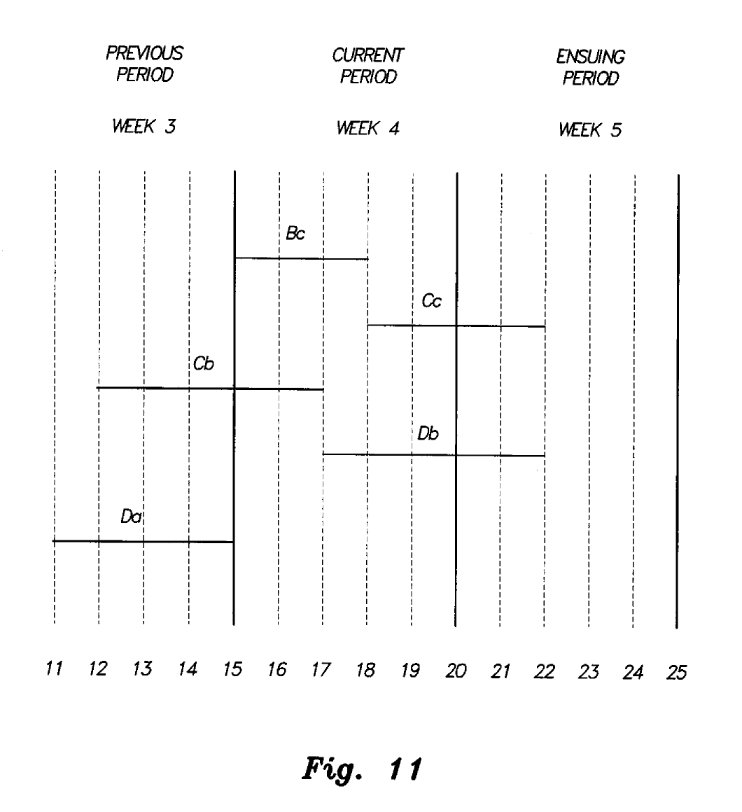

To demonstrate the method of repair to render chromosomes financially feasible under a constrained fund, chromosomes are constructed at fund constraints of $53,000, $50,000 and $47,000. In each week, the total available fund is allocated to select the best schedule of project A and the remaining fund, if any, is allocated to select the best schedule of the project B. Table 4 (shown in FIGS. 2A and 2B) presents the cash flow parameters throughout the 12-week duration of the schedule under a constrained fund of $50,000. The values of the accumulated negative balance of the two 12-activity projects of the chromosomes constructed at fund constraints of $53,000, $50,000 and $47,000 are presented in Table 3 with maximum values of $52,956.60, $49,992.20, and $46,940.10, respectively. The repaired chromosomes constructed at fund constraints of $53,000, $50,000 and $47,000 are shown in FIGS. 8, 9 and 10, respectively.

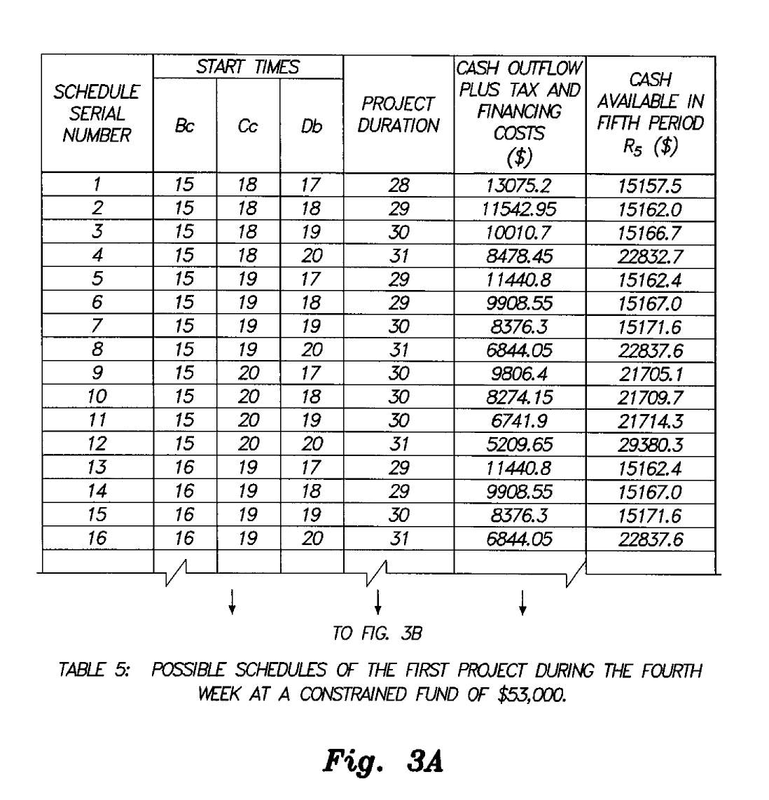

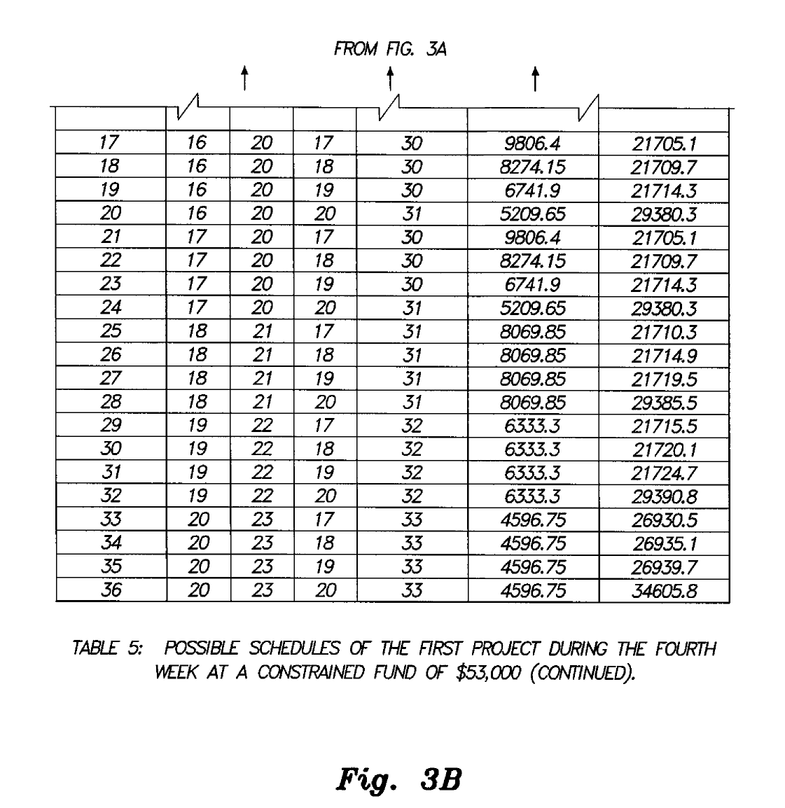

FIG. 11 shows the scheduling of the activities during the fourth week under a constrained fund of $53,000. The situation before scheduling activities at the beginning of the fourth week is such that activities Aa, Ab, Ba, Ac, Bb, Ca, and Da were completed; activity Cb was started during the third week but still has two remaining days during the fourth week; and activities Bc, Cc, Db, and Dc did not start. The set of eligible activities to start during the fourth week encompasses activities Bc, Cc, and Db. The initial schedule of these three activities indicates the early starts of Bc, Cc, and Db are at days 15, 18 and 17, respectively. Table 5 (shown in FIGS. 3A and 3B) presents the total thirty-six possible schedules of the starts of the three activities.

For each schedule, Table 5 presents the total project duration, the cash outflow of each schedule during the fourth week, including tax and financing costs, and the value of R₅. Given that the R₄ value amounts to $11,756.30, the most optimal schedule is the second in the list. Thus, activities Bc, Cc, and Db are scheduled to start at days 15, 18 and 18, respectively, as shown in FIG. 11. The remaining fund of $213.40 will not be utilized, as the second project is supposed to start the fifth week. Based on the finalized schedule of the fourth week, the cash flow parameters are calculated and, consequently, the value of R₅. Being of positive value, R₅ indicates that the leftovers of activities Cc and Db can be achieved during the fifth week and an additional fund of $15,162.4 is available to schedule more activities.

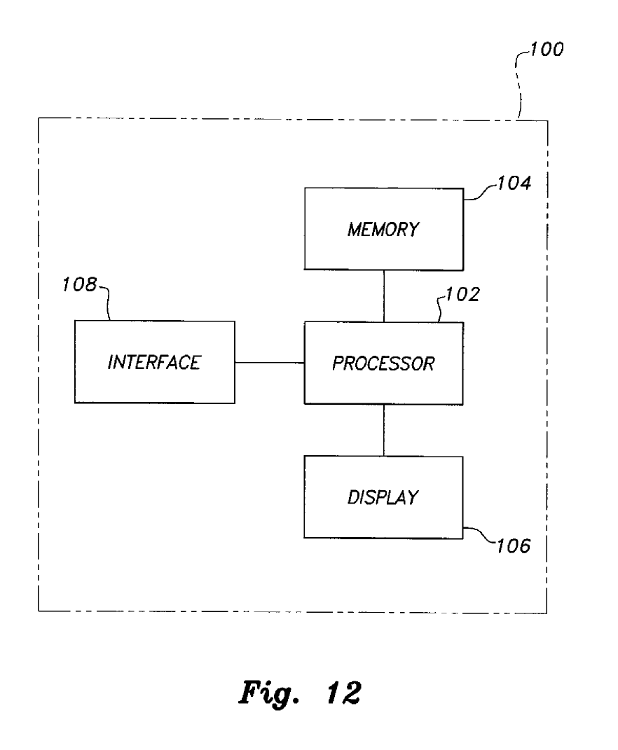

FIG. 12 illustrates a generalized system 100 for implementing the method of repairing financially infeasible genetic algorithm chromosome encoding activity start times in scheduling problems, although it should be understood that the generalized system 100 may represent a stand-alone computer, computer terminal, portable computing device, networked computer or computer terminal, or networked portable device. Data may be entered into the system 100 by the user via any suitable type of user interface 108, and may be stored in computer readable memory 104, which may be any suitable type of computer readable and programmable memory. Calculations are performed by the processor 102, which may be any suitable type of computer processor, and may be displayed to the user on the display 106, which may be any suitable type of computer display.

The processor 102 may be associated with, or incorporated into, any suitable type of computing device, for example, a personal computer or a programmable logic controller. The display 106, the processor 102, the memory 104, and any associated computer readable media are in communication with one another by any suitable type of data bus, as is well known in the art.

Examples of computer readable media include a magnetic recording apparatus, an optical disk, a magneto-optical disk, and/or a semiconductor memory (for example, RAM, ROM, etc.). Examples of magnetic recording apparatus that may be used in addition to memory 104, or in place of memory 304, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

1. A method of repairing financially infeasible genetic algorithm chromosome encoding activity start times in scheduling, comprising the steps of:
(a) establishing a database stored in computer readable memory;
(b) defining a set of variables E(t), P(t) and Uₜ respectively representing a set of activities' cash outflow over a period of time t, a cash inflow for the set of activities at the end of the period of time t, and a total of cash outflow during the period of time t;
(c) setting t=0;
(d) establishing an initial value of the set of activities' cash outflow E(0) and an initial value of the cash inflow for the set of activities P(0) at time t=0 and storing E(0) and P(0) in the database;
(e) iteratively advancing the time period t so that t=t+1;
(f) establishing the total of cash outflow Uₜ for the period of time t and storing Uₜ in the database;
(g) determining cash outflows associated with a set of unscheduled activities during the period of time t, Rₜ, and storing Rₜ in the database;
(h) identifying all possible schedules of eligible activities based on a set of activities already scheduled prior to the period of time t and storing the set of possible schedules in the database;
(i) for each identified schedule in the set of possible schedules, calculating a sum of the cash outflow and financing costs associated therewith;
(j) for each identified schedule in the set of possible schedules, determining a time to finish a project associated therewith;
(k) for each identified schedule in the set of possible schedules, calculating Uₜ₊₁ and Rₜ₊₁ and storing the calculated Uₜ₊₁ and Rₜ₊₁ in the database;
(l) determining the most optimal schedule in the set of possible schedules, wherein the most optimal schedule includes the least delay in time to finish the project associated therewith from the set of possible schedules, has a sum of cash outflow, tax value and financing costs associated therewith less than Rₜ, and the sum is the closest to Rₜ from the set of possible schedules, and Rₜ₊₁ is positive;
(m) storing the most optimal schedule in the database;
(n) scheduling the activities of the most optimal schedule;
(o) determining E(t) and P(t) for cash flow over the period of time t; and
(p) if all activities have not been scheduled, then returning to step (e).

2. The method of repairing financially infeasible genetic algorithm chromosome encoding activity start times in scheduling as recited in claim 1, wherein the step of establishing an initial value of the set of activities' cash outflow E(0) and an initial value of the cash inflow for the set of activities P(0) at time t=0 comprises the steps of:
establishing a set of mobilization costs and bond premiums associated with the set of activities;
calculating a tax value associated with the set of mobilization costs and bond premiums from a tax rate and setting E(0) equal to the tax value; and
establishing an advance payment total for the set of activities and setting P(0) equal to the advance payment total.

3. The method of repairing financially infeasible genetic algorithm chromosome encoding activity start times in scheduling as recited in claim 2, wherein the step of establishing the total of cash outflow Uₜ for the period t comprises the steps of:
determining cash outflow of a set of leftovers of activities scheduled prior to and ongoing through the period of time t;
adding an overhead per time period to the cash outflow of the set of leftovers; and
calculating a leftover tax value and adding the leftover tax value to the sum of the overhead per time period and the cash outflow of the set of leftovers to establish the cash outflow Uₜ for the period t.

4. The method of repairing financially infeasible genetic algorithm chromosome encoding activity start times in scheduling as recited in claim 3, wherein the cash outflows associated with a set of unscheduled activities during the period of time t, Rₜ, are determined with included tax and financing costs, Rₜ being calculated as:
$${R}_{t} = W - {\hat{N}}_{t - 1} - {N}_{t - 1} ( r ) - {\hat{I}}_{t - 1} ( r ) - {U}_{t} ( 1 + \frac{r}{2} ) ,$$
wherein W is a user-specified limit representing a constrained fund, \hat{N}ₜ represents a net cumulative balance including accumulated financing costs at the end of the period of time t and \hat{N}ₜ₋₁ represents the net cumulative balance including accumulated financing costs at the end of the previous period of time t−1, r represents a financing rate per period of time, and Îₜ represents accumulated financing costs at the end of the period of time t and Îₜ₋₁ represents the accumulated financing costs at the end of the previous period of time t−1.

5. The method of repairing financially infeasible genetic algorithm chromosome encoding activity start times in scheduling as recited in claim 4, wherein the accumulated financing costs at the end of the period of time t, Îₜ, is calculated as
$${\hat{I}}_{t} = {\sum }_{l = 1}^{t} {{I}_{l} ( 1 + r )}^{t - l} ,$$
where l is an integer and Iₗ represents total financing costs at the end of time t=1.

6. The method of repairing financially infeasible genetic algorithm chromosome encoding activity start times in scheduling as recited in claim 5, wherein step (o) further includes determining Fₜ, Nₜ, Iₜ, Îₜ, \hat{F}ₜ, and \hat{N}ₜ for the period of time t, where Fₜ represents outstanding debt at the end of period of time t, Nₜ represents net cumulative balance at the end of period of time t, and \hat{F}ₜ represents cumulative balance at the end of the period of time t, including accumulated financing costs, and returning to step (e) if all activities have not been scheduled.

7. A system for repairing financially infeasible genetic algorithm chromosome encoding activity start times in scheduling problems, comprising:
a processor;
computer readable memory coupled to the processor;
a user interface coupled to the processor;
a display; and
software stored in the memory and executable by the processor, the software having:
means for establishing a database stored in the computer readable memory;
means for defining a set of variables E(t), P(t) and Uₜ, respectively, representing a set of activities' cash outflow over a period of time t, a cash inflow for the set of activities at the end of the period of time t, and a total of cash outflow during the period of time t;
means for initially setting t=0;
means for establishing an initial value of the set of activities' cash outflow E(0) and an initial value of the cash inflow for the set of activities P(0) at time t=0 and storing E(0) and P(0) in the database;
means for iteratively advancing the period of time t so that t=t+1;
means for establishing the total of cash outflow Uₜ for the period of time t and storing Uₜ in the database;
means for determining cash outflows associated with a set of unscheduled activities during the period of time t, Rₜ, and storing Rₜ in the database;
means for identifying all possible schedules of eligible activities based on a set of activities already scheduled prior to the period of time t and storing the set of possible schedules in the database;
means for calculating a sum of the cash outflow and financing costs associated with each identified schedule in the set of possible schedules;
means for determining a time to finish a project associated with each identified schedule in the set of possible schedules;
means for calculating Uₜ₊₁ and Rₜ₊₁ and storing the calculated Uₜ₊₁ and Rₜ₊₁ in the database for each identified schedule in the set of possible schedules;
means for determining the most optimal schedule in the set of possible schedules, wherein the most optimal schedule includes the least delay in time to finish the project associated therewith from the set of possible schedules, has a sum of cash outflow, tax value and financing costs associated therewith less than Rₜ, and the sum is the closest to Rₜ from the set of possible schedules, and Rₜ₊₁ is positive;
means for storing the most optimal schedule in the database;
means for scheduling the activities of the most optimal schedule; and
means for determining E(t) and P(t) for cash flow over the period of time t.

8. The system for repairing financially infeasible genetic algorithm chromosome encoding activity start times in scheduling problems as recited in claim 7, wherein the means for establishing an initial value of the set of activities' cash outflow E(0) and an initial value of the cash inflow for the set of activities P(0) at time t=0 comprise:
means for establishing a set of mobilization costs and bond premiums associated with the set of activities;
means for calculating a tax value associated with the set of mobilization costs and bond premiums from a tax rate and setting E(0) equal to the tax value; and
means for establishing an advance payment total for the set of activities and setting P(0) equal to the advance payment total.

9. The system for repairing financially infeasible genetic algorithm chromosome encoding activity start times in scheduling problems as recited in claim 8, wherein the means for establishing the total of cash outflow Uₜ for the period t comprise:
means for determining cash outflow of a set of leftovers of activities scheduled prior to and ongoing through the period of time t;
means for adding an overhead per time period to the cash outflow of the set of leftovers; and
means for calculating a leftover tax value and adding the leftover tax value to the sum of the overhead per time period and the cash outflow of the set of leftovers to establish the cash outflow Uₜ for the period t.

10. The system for repairing financially infeasible genetic algorithm chromosome encoding activity start times in scheduling problems as recited in claim 9, wherein the cash outflows associated with a set of unscheduled activities during the period of time t, Rₜ, are determined with included tax and financing costs, the system further comprising means for calculating Rₜ as
$${R}_{t} = W - {\hat{N}}_{t - 1} - {N}_{t - 1} ( r ) - {\hat{I}}_{t - 1} ( r ) - {U}_{t} ( 1 + \frac{r}{2} ) ,$$
where W is a user-specified limit representing a constrained fund, \hat{N}ₜ represents a net cumulative balance including accumulated financing costs at the end of the period of time t and Nₜ₋₁ represents the net cumulative balance including accumulated financing costs at the end of the previous period of time t−1, r represents a financing rate per period of time, and Îₜ represents accumulated financing costs at the end of the period of time t and Îₜ₋₁ represents the accumulated financing costs at the end of the previous period of time t−1.

11. The system for repairing financially infeasible genetic algorithm chromosome encoding activity start times in scheduling problems as recited in claim 10, further comprising means for calculating Îₜ, wherein Îₜ represents accumulated financing costs at the end of the period of time t, as
$${\hat{I}}_{t} = {\sum }_{l = 1}^{t} {{I}_{l} ( 1 + r )}^{t - l} ,$$
where l is an integer and Iₗ represents total financing costs at the end of time t=l.

12. The system for repairing financially infeasible genetic algorithm chromosome encoding activity start times in scheduling problems as recited in claim 11, wherein the means for means for determining E(t) and P(t) for cash flow over the period of time t further comprises means for determining Fₜ, Nₜ, Iₜ, Îₜ, \hat{F}ₜ, and \hat{N}ₜ for the period of time t, where Fₜ represents outstanding debt at the end of period of time t, Nₜ represents net cumulative balance at the end of period of time t, and Fₜ represents cumulative balance at the end of the period of time t, including accumulated financing costs, and returning to step e) if all activities have not been scheduled.

13. A computer software product that includes a medium readable by a processor, the medium having stored thereon a set of instructions for repairing financially infeasible genetic algorithm chromosome encoding activity start times in scheduling problems, the instructions comprising:
a) a first sequence of instructions which, when executed by the processor, causes the processor to establish a database stored in computer readable memory;
b) a second sequence of instructions which, when executed by the processor, causes the processor to define a set of variables E(t), P(t) and Uₜ, respectively, representing a set of activities' cash outflow over a period of time t, a cash inflow for the set of activities at the end of the period of time t, and a total of cash outflow during the period of time t;
c) a third sequence of instructions which, when executed by the processor, causes the processor to set t=0;
d) a fourth sequence of instructions which, when executed by the processor, causes the processor to establish an initial value of the set of activities' cash outflow E(0) and an initial value of the cash inflow for the set of activities P(0) at time t=0 and storing E(0) and P(0) in the database;
e) a fifth sequence of instructions which, when executed by the processor, causes the processor to iteratively advance the period of time t such that t=t+1;
f) a sixth sequence of instructions which, when executed by the processor, causes the processor to establish the total of cash outflow Uₜ for the period of time t and storing Uₜ in the database;
g) a seventh sequence of instructions which, when executed by the processor, causes the processor to determine cash outflows associated with a set of unscheduled activities during the period of time t, Rₜ, and storing Rₜ in the database;
h) an eighth sequence of instructions which, when executed by the processor, causes the processor to identify all possible schedules of eligible activities based on a set of activities already scheduled prior to the period of time t and storing the set of possible schedules in the database;
i) a ninth sequence of instructions which, when executed by the processor, causes the processor to, for each identified schedule in the set of possible schedules, calculate a sum of the cash outflow and financing costs associated therewith;
j) a tenth sequence of instructions which, when executed by the processor, causes the processor to, for each identified schedule in the set of possible schedules, determine a time to finish a project associated therewith;
k) an eleventh sequence of instructions which, when executed by the processor, causes the processor to, for each identified schedule in the set of possible schedules, calculate Uₜ₊₁ and Rₜ₊₁ and storing the calculated Uₜ₊₁ and Rₜ₊₁ in the database;
l) a twelfth sequence of instructions which, when executed by the processor, causes the processor to determine the most optimal schedule in the set of possible schedules, wherein the most optimal schedule includes the least delay in time to finish the project associated therewith from the set of possible schedules, has a sum of cash outflow, tax value and financing costs associated therewith less than Rₜ, and the sum is the closest to Rₜ from the set of possible schedules, and Rₜ₊₁ is positive;
m) a thirteenth sequence of instructions which, when executed by the processor, causes the processor to store the most optimal schedule in the database;
n) a fourteenth sequence of instructions which, when executed by the processor, causes the processor to schedule the activities of the most optimal schedule;
o) a fifteenth sequence of instructions which, when executed by the processor, causes the processor to determine E(t) and P(t) for cash flow over the period of time t; and
p) a sixteenth sequence of instructions which, when executed by the processor, causes the processor to, if all activities have not been scheduled, return to the fifth sequence of instructions.

14. The computer software product that includes a medium readable by a processor, the medium having stored thereon a set of instructions for repairing financially infeasible genetic algorithm chromosome encoding activity start times in scheduling problems, as recited in claim 13, wherein the fourth sequence of instructions further comprises:
a seventeenth sequence of instructions which, when executed by the processor, causes the processor to establish a set of mobilization costs and bond premiums associated with the set of activities;
an eighteenth sequence of instructions which, when executed by the processor, causes the processor to calculate a tax value associated with the set of mobilization costs and bond premiums from a tax rate and setting E(0) equal to the tax value; and
a nineteenth sequence of instructions which, when executed by the processor, causes the processor to establish an advance payment total for the set of activities and setting P(0) equal to the advance payment total.

15. The computer software product that includes a medium readable by a processor, the medium having stored thereon a set of instructions for repairing financially infeasible genetic algorithm chromosome encoding activity start times in scheduling problems, as recited in claim 14, wherein the sixth sequence of instructions further comprises:
a twentieth sequence of instructions which, when executed by the processor, causes the processor to determine cash outflow of a set of leftovers of activities scheduled prior to and ongoing through the period of time t;
a twenty-first sequence of instructions which, when executed by the processor, causes the processor to add an overhead per time period to the cash outflow of the set of leftovers; and
a twenty-second sequence of instructions which, when executed by the processor, causes the processor to calculate a leftover tax value and adding is the leftover tax value to the sum of the overhead per time period and the cash outflow of the set of leftovers to establish the cash outflow Uₜ for the period t.

16. The computer software product that includes a medium readable by a processor, the medium having stored thereon a set of instructions for repairing financially infeasible genetic algorithm chromosome encoding activity start times in scheduling problems, as recited in claim 15, further comprising a twenty-third sequence of instructions which, when executed by the processor, causes the processor to determine the cash outflows associated with a set of unscheduled activities during the period of time t, Rₜ, with included tax and financing costs as:
$${R}_{t} = W - {\hat{N}}_{t - 1} - {N}_{t - 1} ( r ) - {\hat{I}}_{t - 1} ( r ) - {U}_{t} ( 1 + \frac{r}{2} ) ,$$
wherein W is a user-specified limit representing a constrained fund, \hat{N}ₜ represents a net cumulative balance including accumulated financing costs at the end of the period of time t and \hat{N}ₜ₋₁ represents the net cumulative balance including accumulated financing costs at the end of the previous period of time t−1, r represents a financing rate per period of time, and Îₜ represents accumulated financing costs at the end of the period of time t and Îₜ₋₁ represents the accumulated financing costs at the end of the previous period of time t−1.

17. The computer software product that includes a medium readable by a processor, the medium having stored thereon a set of instructions for repairing financially infeasible genetic algorithm chromosome encoding activity start times in scheduling problems, as recited in claim 16, further comprising a twenty-fourth sequence of instructions which, when executed by the processor, causes the processor to calculate the accumulated financing costs at the end of the period of time t, Îₜ, as
$${\hat{I}}_{t} = {\sum }_{l = 1}^{t} {{I}_{l} ( 1 + r )}^{t - l} ,$$
where l is an integer and Iₗ represents total financing costs at the end of time t=1.

18. The computer software product that includes a medium readable by a processor, the medium having stored thereon a set of instructions for repairing financially infeasible genetic algorithm chromosome encoding activity start times in scheduling problems, as recited in claim 17, wherein the fifteenth sequence of instructions further comprises a twenty-fifth sequence of instructions which, when executed by the processor, causes the processor to determine Fₜ, Nₜ, Iₜ, Îₜ, \hat{F}ₜ, and \hat{N}ₜ for the period of time t, where Fₜ represents outstanding debt at the end of period of time t, Nₜ represents net cumulative balance at the end of period of time t, and \hat{F}ₜ represents cumulative balance at the end of the period of time t, including accumulated financing costs, and returning to the fifth sequence of instructions if all activities have not been scheduled.
